(19) United States
(12) Patent Application Publication
(10) Pub. No.: US 2009/0177324 A1
(43) Pub. Date: Jul. 9, 2009

(54) Robot system and method for maxibags sampling in ore concentration processes

(76) Inventor: Hugo Salamanca, Santiago (CL)

Correspondence Address: GOTTLIEB RACKMAN & REISMAN PC, 270 MADISON AVENUE, 8TH FLOOR, NEW YORK, NY, 10016-0601, US

(21) Appl. No.: 11/595,964

(22) Filed: Nov. 13, 2006

Related U.S. Application Data
(60) Provisional application No. 60/734,971, filed on Nov. 10, 2005.

(51) Int. Cl. G05B 15/00

(52) U.S. Cl. 700/260; 901/2

(57) ABSTRACT

At present, the molybdenum sampling process in maxibags is carried out manually and it has the disadvantage of being carried out manually which causes the system efficiency to decrease due to the less representativeness of the samples obtained.

Due to the above, a robot system and method have been developed for the sample taking of molybdenum in an automatic way so as to ensure the representativeness of the sampling as well as the control over the product to be commercialized.

The robotic system is composed mainly of a robotic manipulator (1) of at least 5 degrees of freedom, and a gripping mechanism (2) which allows to take the sampling device (3) from a tool holder (4) located at on of its sides, moving it through a defined path to the sampling area (5), where the sampling process will take place, in a sequential and programmed way, to certain number of maxibags faces to be defined (7).

### CROSS-REFERENCE TO RELATED APPLICATIONS

This application claims the benefit of provisional patent application Ser. No. 60/734,971 filed 2005 Nov. 10 by the present inventor

### FEDERAL SPONSORED RESEARCH

Not Applicable

### SEQUENCE LISTING OR PROGRAM

Not Applicable

### BACKGROUND

1. Field of Invention

This invention relates to the use of robotic technology in mining industry, specifically in improving the representativeness of material sampling

2. Prior Art

Once the mineral is extracted from the mine, it must be subjected to a treatment to increase its purity. This metallurgical treatment is called concentration, which is carried out in a concentrating plant usually located near the production unit of the mine. This plant concentrates the minerals, until their metal content reaches commercial values. The stages of this process are crushing and grinding (the progressive reduction of particles until reaching sizes lower than one millimeter), followed by the flotation process using chemical reagents, where the valuable mineral (copper and molybdenum concentrates) is separated from the gangue (which is the worthless material, called tailing).

For molybdenum concentrate, after its processing in a concentrator, it is stored in hoppers or in closed warehouses and its permanence as stock depends on the sales program, availability of transport units, etc.

After that, the concentrate is put in bags so it is stored in the so called Maxibags. In this stage and for the purposes of quality control, the humidity, the product grade and the weight of the unit to be transported are determined.

Finally, the loading takes place, the frontal loaders which deposit the concentrate in the hopper of the transportation unit (trucks or wagons) which is covered with a canvas attached with chains or a rope to avoid losses of the product during the transportation.

The importance of the sampling process of minerals is based on the fact that all the decisions made in relation to the Mining project, from exploration to the closing of the mine, are based on values obtained from the sampled material, for which sample is a part or portion extracted from a group by using methods allowing to consider this as a representative part of the average quality and conditions of a group or the technique employed in this selection or the selection of a part statistically determined to deduce the value of one or more characteristics of the group.

Particularly, the task of molybdenum sampling in MaxiBags has the disadvantage of being carried out manually which causes the system to be less efficient due to the low representativeness of the samples obtained.

### SUMMARY

A Robot System and Method have been developed to carry out the sampling tasks for molybdenum in an automated way, so as to ensure the representativeness of the sample and the control over the product to be commercialized.

### DRAWINGS

### Figures

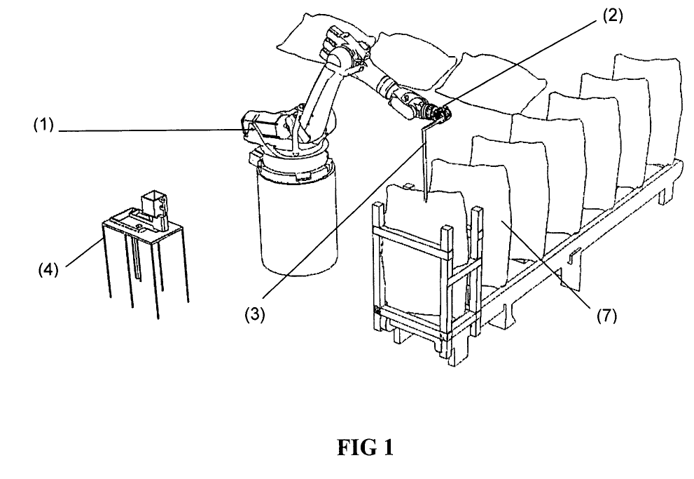

FIG. 1. View of a robotic manipulator taking a sample of the molybdenum concentrate inside the maxibags.

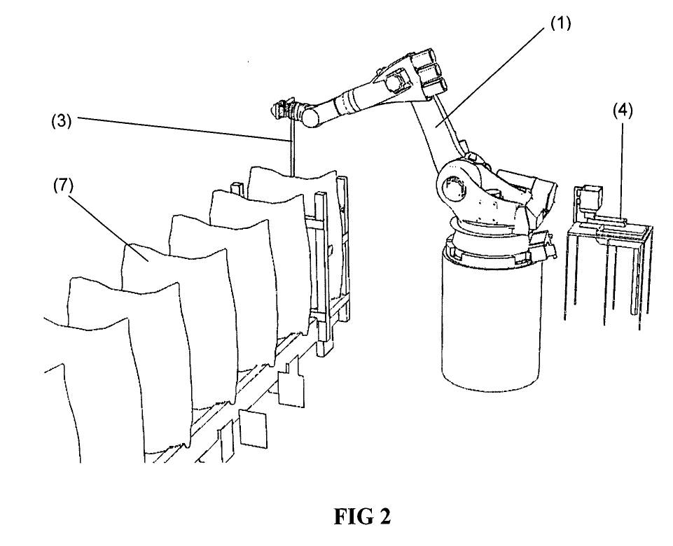

FIG. 2. General view of a robot system for maxibags sampling.

### REFERENCE NUMERALS

1. Robotic manipulator
2. Gripping mechanism
3. Tool
4. Tool holder
5. Maxibag

### DETAILED DESCRIPTION

This invention relates to a new robot system as well as a robotic method for the sampling of maxibags, which are carried out automatically through anthropomorphous robotic arms of at least 5 degrees of freedom, which are installed at one side of the sampling area.

With reference to FIGS. No 1 and 2, the robot system is composed mainly of one robotic manipulator (1) of at least 5 degrees of freedom, provided with a communication, acquisition and control system, and a gripping mechanism (2) to allow, in a sequential and programmed way, to take, manipulate, and release a sampling device or tool (3) from a tool holder (4) located at one of its sides, which is moved through a defined path to the sampling area, where the sampling process will take place, in a sequential and programmed way, to a certain number of maxibags to be defined (5).

I claim:

1. A robot system for the sampling of maxibags in ore concentration processes comprising an anthropomorphous robotic arm of at least 5 degrees of freedom, one control, communication and programming unit, one gripper adapter, one pneumatic gripper, its fingers, one pneumatic gripper driving system, one electric supply system and a sampling device or apparatus wherein the anthropomorphous robotic arm of at least 5 degrees of freedom is provided with a pneumatic gripping mechanism which allows in a sequential and programmed way to take, manipulate and release a sampling device and apparatus and moves it through a defined path, until reaching the maxibags area, where the concentrate sampling is carried out to a certain number of maxibags to be defined.

2. A robot system for the sampling of maxibags in ore concentration processes according to claim 1, wherein the robotic manipulator is provided with a gripping mechanism which allows to take, manipulate and release a sampling device or tool from a fixed and/or mobile tool holder located at one of its sides and moves it within the work volume of the robotic system.

3. A robot system for the sampling of maxibags in ore concentration processes according to claim 1, wherein the robotic manipulator of at least 5 degrees of freedom is mounted on fixed and/or mobile support located between the tool holder and the maxibags.

4. A robot system for the sampling of maxibags in ore concentration processes according to claim 1, wherein the anthropomorphous robotic manipulator could communicate by itself or through a PLC interface with the control system.

5. A robot system for the sampling of maxibags in ore concentration processes according to claim 1, wherein the anthropomorphous robotic manipulator has the capacity to obtain and interpret the information of installed analogue and/or digital sensors.

6. A robot system for the sampling of maxibags in ore concentration processes according to claim 1, wherein the anthropomorphous robotic manipulator has the capacity to generate analogue and/or digital signals to control analogue and/or digital input devices.

7. A robot system for the sampling of maxibags in ore concentration processes according to claim 1, wherein a tool holder is provided from where the anthropomorphous robotic arm of at least 5 degrees of freedom takes a sampling device and moves it through a defined path to the maxibags area in which sampling will take place to a certain amount of maxibags to be defined.

8. A robot system for the sampling of maxibags in ore concentration processes according to claim 1, wherein a sampling device is provided which is used to carry out the sampling of maxibags.

9. A robot system for the sampling of maxibags in ore concentration processes according to claim 1, wherein the anthropomorphous robotic manipulator has an electrical system driven by three-stage induction motors, with vectorial and/or scalar control.

10. A robot system for the sampling of maxibags in ore concentration processes according to claim 1, wherein productivity and efficiency in the sampling of concentrate and/or minerals, thus improving the representativeness of the sample and the quality control of the product to be commercialized.

11. A robot system for the sampling of maxibags in ore concentration processes according to claim 1, wherein it could be integrated not only to ore concentration processes of different metals such as cooper, molybdenum, zinc, lead, etc., but also it could be used for sampling, either selectively or compositum, in a wide range of other industrial productive processes.

12. A robot system for the sampling of maxibags in ore concentration processes according to claim 1, wherein the system may operate automatically, or semiautomatically, and also allows solutions scalability

13. A robotic method for the sampling of maxibags in ore concentration processes using the robot System of claim 1 to 12, wherein the anthropomorphous robotic arm of at least 5 degrees of freedom is provided with a pneumatic gripping mechanism which allows in a sequential and programmed way to take, manipulate and release a sampling device and apparatus and moves it through a defined path, until reaching the maxibags area, where the concentrate sampling is carried out to a certain number of maxibags to be defined.

14. A robotic method for the sampling of maxibags in ore concentration processes using the robot System of claim 1 to 12, wherein the robotic manipulator is provided with a gripping mechanism which allows in a sequential and programmed way to take, manipulate and release a sampling device or tool from a fixed and/or mobile tool holder located at one of its sides and moves it within the work volume of the robotic system.

15. A robotic method for the sampling of maxibags in ore concentration processes using the robot System of claim 1 to 12, wherein the robotic manipulator of at least 5 degrees of freedom, is mounted on a fixed and/or mobile support located between the tool holder and the maxibags.

16. A robotic method for the sampling of maxibags in ore concentration processes using the robot System of claim 1 to 12, wherein the anthropomorphous robotic manipulator could communicate by itself or through a PLC interface with the control system.

17. A robotic method for the sampling of maxibags in ore concentration processes using the robot System of claim 1 to 12, wherein the anthropomorphous robotic manipulator has the capacity to obtain and interpret the information from installed analogue and/or digital sensors.

18. A robotic method for the sampling of maxibags in ore concentration processes using the robot System of claim 1 to 12, wherein the anthropomorphous robotic manipulator has the capacity to generate analogue and/or digital signals to control the analogue and/or digital inputs devices.

19. A robotic method for the sampling of maxibags in ore concentration processes using the robot System of claim 1 to 12, wherein a tool holder is provided from where the anthropomorphous robotic arm of at least 5 degrees of freedom takes a sampling device and moves it through a defined path to the maxibags area in which sampling will take place to a certain amount of maxibags to be defined.

20. A robotic method or the sampling of maxibags in ore concentration processes using the robot System of claim 1 to 12, wherein a sampling device is provided which is used to carry out the sampling of maxibags.

21. A robotic method for the sampling of maxibags in ore concentration processes using the robot System of claim 1 to 12, wherein the anthropomorphous robotic manipulator has an electrical system driven by three-stage induction motors with vectorial and/or scalar control

22. A robotic method for the sampling of maxibags in ore concentration processes using the robot System of claim 1 to 12, wherein productivity and efficiency in the sampling of concentrate and/or minerals, thus improving the representativeness of the sample and the quality control of the product to be commercialized.

23. A robotic method for the sampling of maxibags in ore concentration processes using the robot System of claim 1 to 12, wherein it could be integrated not only to ore concentration processes of different metals such as cooper, molybdenum, zinc, lead, etc., but also it could be used for sampling, either selectively or compositum, in a wide range of other industrial productive processes.

24. A robotic method for the sampling of maxibags in ore concentration processes using the robot System of claim 1 to 12, wherein the system may operate automatically or semi-automatically, and also allows solution scalability.
